(19) United States
(12) Patent Application Publication
(10) Pub. No.: US 2025/0127332 A1
(43) Pub. Date: Apr. 24, 2025

(54) TOASTER WITH PLATES FOR DOUBLE SIDE CONTACT

(71) Applicant: Song Bum PARK, Taean-gun (KR)

(72) Inventor: Song Bum PARK, Taean-gun (KR)

(21) Appl. No.: 18/490,405

(22) Filed: Oct. 19, 2023

(51) Int. Cl. A47J 37/08

(52) U.S. Cl. CPC A47J 37/08

(57) ABSTRACT

Provided is a toaster with plates for double side contact, including a plurality of insertion holes formed on an upper portion of a main body, a heating space in an internal space communicating with the plurality of insertion holes, in which a bread is placed and heated in the heating space, and two contact plates positioned vertically on both sides of the bread placed into the heating space, in which the contact plates are movably provided so as to be moved horizontally in a transverse direction such that upon placing the bread, at least one of the two contact plates is moved in a horizontal direction into a close contact with both sides of the bread to heat the bread while in the close contact with both sides of the bread, and the contact plate includes a heating plate or a glass plate.

### BACKGROUND

### Technical Field

The disclosure relates to an electric toaster for toasting bread, which includes contact plates that can heat a bread placed therebetween while in the close contact with both sides of the placed bread to provide the bread having a good texture.

### Description of Related Art

Generally, a toaster is used to toast bread. A related electric toaster has an insertion hole formed on an upper portion, a heating space formed in an internal space communicating with the insertion hole, in which the heating space includes several vertical and horizontal wires formed therein, and electric heating elements disposed on both sides of the heating space, respectively. Further, it also generally includes a pull-out device which lifts up the heating space according to a timer, and a timer button provided on an exterior of the main body.

User inserts bread through the insertion hole on the upper portion of the main body, sets the time by operating the timer button, and the placed bread is toasted. When toasting is complete, the bread pops out of the insertion hole by the operation of the pull-out device so that it is easy to take it out.

One example of the related toaster is disclosed in Korean Registered Utility Model No. 20-0468711. To briefly explain the related art, with reference to FIG. 1, the toaster includes a casing 10 that provides a bread seating space 11 in which the bread B can be placed and seated, an electric heating wire support plate 41 installed in the casing 10 to heat the bread B, in which the electric heating wire support plate 41 is fixed to the inside of the casing 10, an electric heater 40 including an electric heating wire 42 fixed to the electric heating wire support plate 41, and a controller installed on a front side of the casing 10, thereby heating the bread placed therein.

As shown in the drawing, the related toaster has a structure in which the electric heating wire 42 for heating the bread is arranged at constant interval from the bread so that the heat from the heating wire is transferred to the bread through the air and brown the bread.

Meanwhile, toasting the bread in this way keeps both sides of the bread being exposed to the air, and accordingly, the bread becomes hard and the moisture in the bread evaporates while heat is delivered to the bread. As a result, the bread popped out of the toaster is hard because moisture has evaporated, making the bread less moist and have a lowered texture and taste.

### SUMMARY

The purpose of the disclosure is to provide an electric toaster for toasting bread, which keeps moist feeling and softness of the bread after toasting.

According to an embodiment, a toaster with plates for double side contact may include a plurality of insertion holes formed on an upper portion of a main body, a heating space in an internal space communicating with the plurality of insertion holes, in which a bread is placed and heated in the heating space, and two contact plates positioned vertically on both sides of the bread placed into the heating space, in which the contact plates may be movably provided so as to be moved horizontally in a transverse direction such that upon placing the bread, at least one of the two contact plates is moved in a horizontal direction into a close contact with both sides of the bread to heat the bread while in the close contact with both sides of the bread, and the contact plate may include a heating plate or a glass plate.

The toaster may further include a spring provided on one side of the at least one of the two contact plates to apply elastic force, and a stop member positioned on the other side opposite the one side of the contact plate where the spring is positioned and restricting the horizontal movement of the contact plate, in which, when the bread is placed into the heating space, the restriction of the stop member may be released so that the contact plate is moved horizontally by the elastic force of the spring into a close contact with the bread.

Additionally, according to an embodiment, a toaster with plates for double side contact may include a plurality of insertion holes formed on an upper portion of a main body, a heating space in an internal space communicating with the plurality of insertion holes, in which a bread is placed and heated in the heating space, and two contact plates positioned on both sides of the bread placed into the heating space, in which at least one of the contact plates may be pivotably provided so as to be pivoted on a lower end such that upon placing the bread, at least one of the two contact plates is pivoted on the lower end into a close contact with both sides of the bread to heat the bread while in the close contact with both sides of the bread, and the contact plate may include a heating plate glass plate.

The toaster may further include a pivot provided on a lower end of any one of the two contact plates so that pivoting occurs based on the same, a spring provided on one side of the contact plate where the pivot is provided, so as to apply elastic force, and a pivoting stop member that restricts pivoting of the pivot, in which, when the bread is placed into the heating space, the restriction of the pivoting stop member may be released so that the contact plate is pivoted on the pivot into a close contact with the bread by the elastic force of the spring.

The toaster according to the disclosure toasts bread placed therein with the heating plate or glass plate in close contact with the bread, and therefore, the moisture in the bread can be kept and the toasted bread with a moist feeling and softness can be provided.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 illustrates internal structure of a related toaster;

FIG. 2 illustrates an example of internal structure of a toaster according an embodiment;

FIGS. 3 and 4 are provided to help understanding of the various principles in which heating plates are in close contact with bread in a toaster according to an embodiment, by showing an exemplary principle in which the heating plates are in close contact with both sides of the bread; and

FIGS. 5 to 7 illustrate another embodiment of a toaster, in which transparent tempered glass plates are used instead of a heating plate to be brought into a direct contact with the bread, showing the bread toasted with the glass plates in close contact with both sides of the bread.

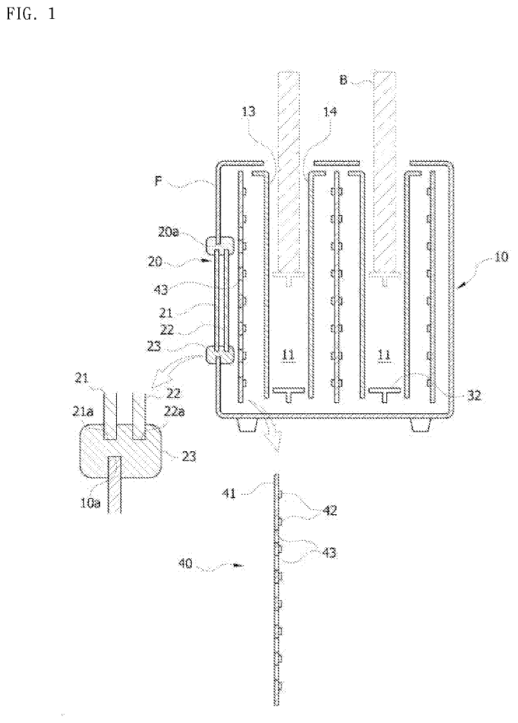

### DETAILED DESCRIPTION

The objectives, specific advantages and novel features of the present disclosure will become more apparent from the following detailed description and the preferred embodiments, which are associated with the accompanying drawings. In addition, terms described herein are terms defined in consideration of functions in the present invention, which may vary according to the intention or convention of a user or an operator. Therefore, definitions of these terms should be made based on the contents throughout the present specification.

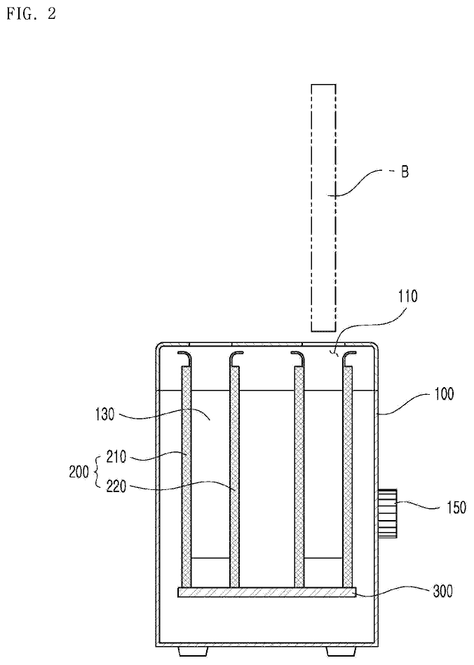

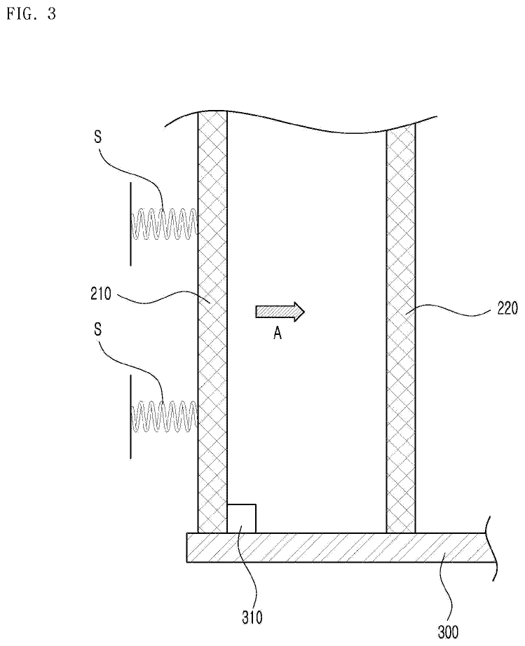

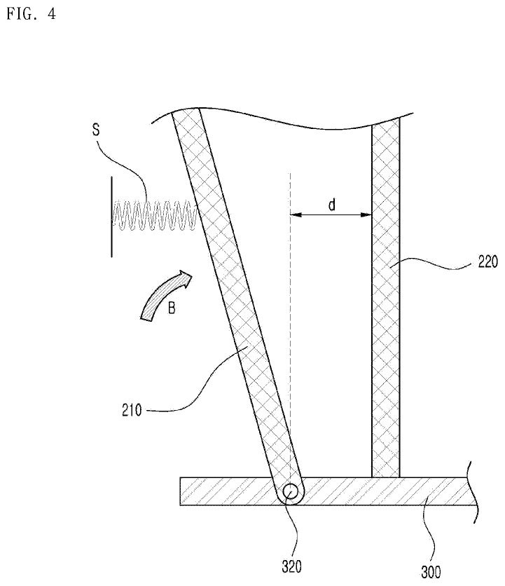

FIG. 2 illustrates an example of internal structure of a toaster according an embodiment, and FIGS. 3 and 4 are provided to help understanding of the various principles in which heating plates are in close contact with bread in a toaster according to an embodiment, by showing an exemplary principle in which the heating plates are in close contact with both sides of the bread. The main feature of the disclosure is that the heating plates are in close contact with both sides of the bread while heating the bread in the toaster, and various methods and structures are available to move the heating plates for this purpose. It is to be noted that a structure illustrated in FIGS. 3 and 4 is an example provided to explain a method for moving the heating plates into a close contact.

The essence of the disclosure is to provide plate-shaped members (hereinafter, referred to as ‘contact plates’ for convenience of explanation) that can heat and toast bread placed into the toaster while in the close contact with both sides of the bread so as to brown the bread in a good texture.

The contact plate may include heating means (heating wire, etc.) provided therein so that the contact plates may directly toast the bread. In this case, the contact plates are the heating plates. In another example, the contact plates may be transparent glass plates (tempered glass plates) that do not have the heating function and only have a function of contacting both sides of the bread. In this case, the glass plates hold both sides of the bread and a separate heating means (heating wire, etc.) is installed in the toaster. Hereinbelow, two embodiments will be mainly described.

### [Structure of Closely Contacting Heating Plate]

Referring to FIGS. 2 to 4, an example in which the contact plates are the heating plates with a direct heating function is illustrated. In FIGS. 2 to 4, the contact plates are the heating plates, so in this embodiment, the contact plates will be referred to as the ‘heating plate’.

The electric toaster according to an embodiment includes a plurality of insertion holes 110 formed on an upper portion of the main body 100, a plurality of heating spaces for storing and heating the bread B, which are formed in an internal space communicating with the plurality of insertion holes 110, and a timer 150 installed on an exterior of the main body 100. A vertical guide groove is formed on one side of the main body, and a lever inserted into the guide groove and connected to each heating space 130 is provided so that a slice of loaf bread (or any type of bread) can be descended when inserted. Then, when the time set by the timer elapses, the bread in the heating space 130 is lifted and popped out. Meanwhile, the structure and method described above are well known in the art employed in a typical toaster, and are not the main features of the disclosure and will not be described in detail below.

The feature of the disclosure is that the heating plates heat the bread placed into the toaster while in the close contact with both sides of the bread. In the toaster according to the disclosure, the bread is placed and heated in the heating space which is an internal space communicating with the insertion hole on the upper portion of the main body 100, and there are two heating plates positioned vertically on both sides of the bread placed into the heating space.

The heating plate 200 has a shape of a plate, is arranged vertically in the heating space, and is movable horizontally in a transverse direction. Further, when the bread is placed into the heating space, any one of the two heating plates 200 is moved in a horizontal direction into a close contact with both sides of the bread so as to heat the bread while in the close contact with both sides of the bread. Both of the two heating plates 200 may be moved in the horizontal direction close to each other into a close contact with both sides of the bread.

Various methods may be employed to move the heating plate 200 in the horizontal direction and aspects of the disclosure are not limited to any one method. Meanwhile, the method of FIGS. 3 and 4 may be considered as an example.

Referring to FIG. 3, the heating plates 200 include two heating plates 210 and 220 facing with each other. In an example in which any one of the two heating plates 210 is moved in the horizontal direction, a spring(s) that applies elastic force is positioned on one side of the moving heating plate 210. A stop member 310 that restricts the horizontal movement of the heating plate is positioned on the other side opposite the one side of the heating plate where the spring is positioned. That is, the heating plate 210 receiving the force of the spring in the horizontal direction is restricted in its movement by the stop member 310.

In this state, when the bread is placed into the heating space, the restriction of the stop member 310 may be released by the user manually (or automatically in response to detecting the insertion of the bread). In response to the released stop member, the heating plate 210 receiving the spring force is moved into a close contact with both sides of the bread. Regarding the force of the spring, the magnitude of elastic force of the spring may be appropriately determined by considering the magnitude of elastic force applied to the heating plate and how close the plate is brought into a contact with both sides of the bread. This allows the heating plate to be brought into a close contact with the bread by the proper elastic force of the spring.

The heating member 200 may include any material such as copper or metal, as long as it is electric heating plate formed in rectangular shape and having a predetermined area. It is also possible to manufacture a flat plate with another material and coat the same with a metal.

Further, according to an embodiment, it is also possible to bring the heating plate into a close contact with both sides of the bread by way of pivoting (turning) the heating plate. Referring to FIG. 4, at least one of the two heating plates 210 is configured to be pivotable on a lower end thereof. When the bread is placed, the heating plate 210 may be pivoted on the lower end into a close contact with both sides of the bread so as to heat the bread while in the close contact with both sides of the bread. In order to allow the heating plate to be pivoted into a close contact with both sides of the bread, it is preferable that a distance (d) between the lower end of the pivoting heating plate and the other heating plate is equal to or slightly smaller than a width of the bread.

A pivot 320 is an axis on which the heating plate 210 is pivoted, and it is positioned at a proper portion of the lower end of the heating plate 210, and provided at a proper portion of a frame in the main body. Further, a spring(s) is provided on one side of the heating plate where the pivot is provided, so as to apply elastic force to the heating plate. In addition, a pivoting stop member (not shown) that restricts pivoting on the pivot is further provided. The pivoting stop member is provided to stop the pivoting of the heating plate 210 so that the heating plate 210 cannot be pivoted before the bread is placed. The pivoting stop member maintains the state shown in FIG. 4.

In this state, when the bread is placed into the heating space, the pivoting stop member releases the heating plate 210 from the restricted state to the pivotable state. By the elastic force of the spring(s), the heating plate 210 is pivoted on the pivot into a close contact with the bread.

The operation of the configuration described above will be described below. Bread B is inserted into the insertion hole 110 of the main body 100, and with the method described above, the heating plate 200 is moved horizontally or pivoted into a close contact with both sides of the bread B. Then, the timer is set to a proper time and a switch is pressed such that electricity is supplied to the heating plate and heating starts. Because the toaster according to an embodiment toasts both sides of the bread with the heating plates in close contact, the moisture in the bread can be kept and the toasted bread with a moist feeling and softness can be provided.

### [Structure of Closely Contacting Glass Plate]

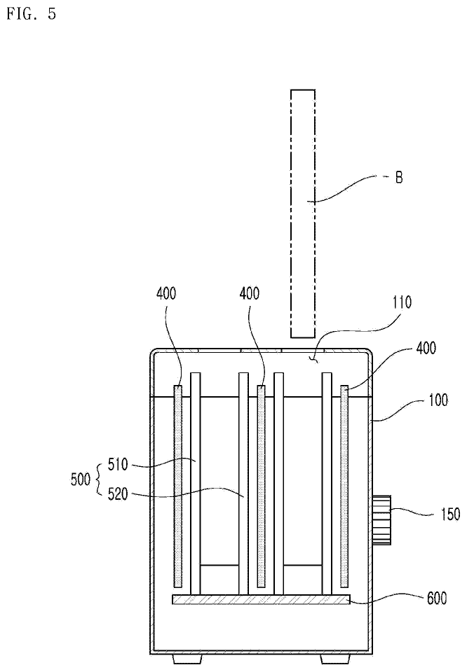

Referring to FIGS. 5 to 7, an example in which the contact plates are glass plates including transparent tempered glass and do not provide direct heating function is illustrated. The glass plates are in close contact with both sides of the bread to block moisture evaporation, and as is the case with the related toaster, heat supply for heating is provided by a separate heating means. The contact plates in FIGS. 5 to 7 are the glass plates, and will be called ‘glass plate’ in the following embodiment.

In the toaster according to this embodiment, the bread is placed and heated in the heating space which is an internal space communicating with an insertion hole on an upper portion of the main body 100, and the structure of heating the bread placed into the heating space or the like is same as the method described above.

According to this embodiment, a heating means 400 that provides a heat source for heating the bread, and two glass plates 500 positioned vertically on both sides of the bread are further provided. The heating means is a component that can generate heat by receiving electric power, and various types of heating means used in the related toasters may be used.

The glass plate 500 has a shape of a plate, is arranged vertically in the heating space, and is movable horizontally in a transverse direction. When the bread is placed into the heating space, one of the two glass plates 500 is moved in the horizontal direction into a close contact with both sides of the bread, and in this state, the heat from the heating means 400 heats the bread. For easy heat transfer from the heating means to the bread, the glass plate may be transparent and formed of tempered glass. Both of the two glass plates 500 may be moved in the horizontal direction close to each other into a close contact with both sides of the bread.

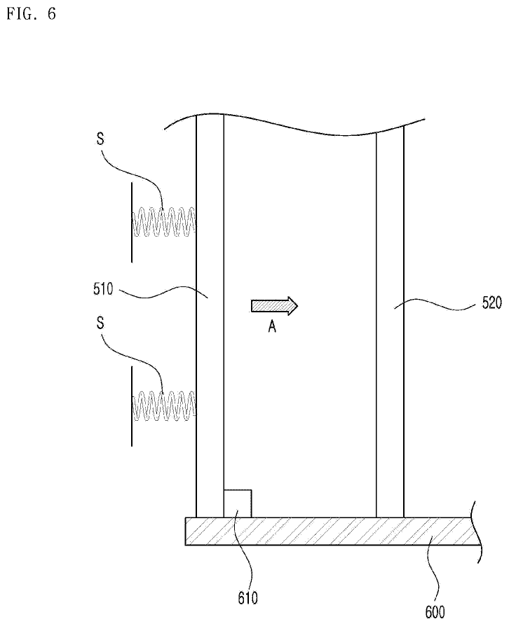

Referring to FIG. 6, the glass plates 500 include two glass plates 510 and 220 facing with each other. In an example in which any one of the two glass plates 510 is moved in the horizontal direction, a spring(s) that applies elastic force is positioned on one side of the moving glass plate 510. A stop member 610 that restricts the horizontal movement of the glass plate is positioned on the other side opposite the one side of the glass plate where the spring is positioned. That is, the glass plate 510 receiving the force of the spring in the horizontal direction is restricted in its movement by the stop member 610. In the drawing, a reference numeral 600 denotes a support member that supports the glass plate from below.

In this state, when the bread is placed into the heating space, the restriction of the stop member 610 is released, and the glass plate 510 receiving the spring force is moved into a close contact with both sides of the bread. Regarding the force of the spring, the magnitude of elastic force of the spring may be appropriately determined by considering the magnitude of elastic force applied to the glass plate and how close the plate is brought into a contact with both sides of the bread.

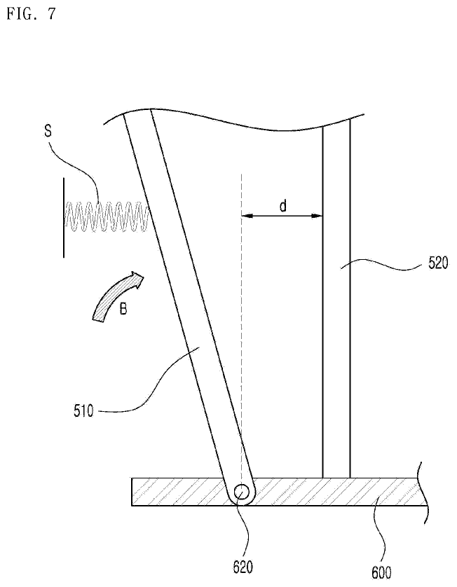

Further, according to an embodiment, it is also possible to bring the glass plate into a close contact with both sides of the bread by way of pivoting (turning) the glass plate. Referring to FIG. 7, at least one of the two glass plates is pivotable on a lower end thereof. When the bread is placed, the glass plate may be pivoted on the lower end into a close contact with both sides of the bread so as to heat the bread while in the close contact with both sides of the bread. In order to allow the glass plate to be pivoted into a close contact with both sides of the bread, it is preferable that a distance (d) between the lower end of the pivoting glass plate and the other glass plate is equal to or slightly smaller than a width of the bread.

A pivot 620 is an axis on which the glass plate 510 is pivoted, and it is positioned at a proper portion of the lower end of the glass plate 210, and provided at a proper portion of a frame in the main body. Further, a spring(s) is provided on one side of the glass plate where the pivot is provided, so as to apply elastic force to the glass plate. In addition, a pivoting stop member (not shown) that restricts pivoting of the pivot is further provided. The pivoting stop member is a member configured to stop the pivoting of the glass plate so that it cannot be pivoted before the bread is placed. In the examples described above, the operation of moving the glass plate is similar to that of moving the heating plate.

The present invention has been described in detail. However, it should be understood that the detailed description and specific examples, while indicating preferred embodiments of the invention, are given by way of illustration only, since various changes and modifications within the scope of the invention will become apparent to those skilled in the art from this detailed description.

1. A toaster with plates for double side contact, comprising:
a plurality of insertion holes formed on an upper portion of a main body, a heating space in an internal space communicating with the plurality of insertion holes, wherein a bread is placed and heated in the heating space, and two contact plates positioned vertically on both sides of the bread placed into the heating space, wherein
the contact plates are movably provided so as to be moved horizontally in a transverse direction such that upon placing the bread, at least one of the two contact plates is moved in a horizontal direction into a close contact with both sides of the bread to heat the bread while in the close contact with both sides of the bread, and the contact plate includes a heating plate or a glass plate.

2. The toaster of claim 1, further comprising:
a spring provided on one side of the at least one of the two contact plates to apply elastic force; and
a stop member positioned on the other side opposite the one side of the contact plate where the spring is positioned and restricting the horizontal movement of the contact plate, wherein,
when the bread is placed into the heating space, the restriction of the stop member is released so that the contact plate is moved horizontally by the elastic force of the spring into a close contact with the bread.

3. A toaster with plates for double side contact, comprising:
a plurality of insertion holes formed on an upper portion of a main body, a heating space in an internal space communicating with the plurality of insertion holes, wherein a bread is placed and heated in the heating space, and two contact plates positioned on both sides of the bread placed into the heating space, wherein
at least one of the contact plates is pivotably provided so as to be pivoted on a lower end such that upon placing the bread, at least one of the two contact plates is pivoted on the lower end into a close contact with both sides of the bread to heat the bread while in the close contact with both sides of the bread, and the contact plate includes a heating plate or a glass plate.

4. The toaster of claim 3, further comprising:
a pivot provided on a lower end of any one of the two contact plates so that pivoting occurs based on the same;
a spring provided on one side of the contact plate where the pivot is provided, so as to apply elastic force; and
a pivoting stop member that restricts pivoting of the pivot, wherein,
when the bread is placed into the heating space, the restriction of the pivoting stop member is released so that the contact plate is pivoted on the pivot into a close contact with the bread by the elastic force of the spring.
